(19) United States
(12) Patent Application Publication
(10) Pub. No.: US 2026/0073489 A1
(43) Pub. Date: Mar. 12, 2026

(54) MEDIA GENERATION METHOD, APPARATUS, DEVICE, AND MEDIUM

(71) Applicant: Beijing Zitiao Network Technology Co., Ltd., Beijing (CN)

(72) Inventors: Wanquan FENG, Beijing (CN); Jiawei LIU, Beijing (CN); Pengqi TU, Beijing (CN)

(21) Appl. No.: 19/395,542

(22) Filed: Nov. 20, 2025

(30) Foreign Application Priority Data
Nov. 22, 2024 (CN) 202411686695.3

(51) Int. Cl. G06T 5/70; G06T 5/50; G06T 7/246

(52) U.S. Cl. CPC G06T 5/70; G06T 5/50; G06T 7/248; G06T 2207/30241

(57) ABSTRACT

The present disclosure provides a media generation method, an apparatus, a device, and a medium. A specific implementation of the method includes: obtaining a reference image and a noise image; obtaining control information for guiding media generation, the control information including information of a target subject in the reference image, information of a processing category to which the target subject belongs, and movement guidance information of the target subject; and performing, using a target model and based on the reference image and the control information, denoising processing on the noise image to obtain a target media, such that the target subject in the target media moves according to the movement guidance information.

### CROSS REFERENCE TO RELATED APPLICATIONS

This present application claims the benefit of priority to Chinese Application No. 202411686695.3, filed on Nov. 22, 2024, the entire contents of which are incorporated herein by reference.

### TECHNICAL FIELD

Embodiments of the present disclosure relate to the field of machine learning technologies and, in particular, to a media generation method, an apparatus, a device, and a medium.

### BACKGROUND

Currently, a machine learning-based method may be used to generate a related video or animation based on an existing image. In related technologies, a video or animation is generally generated based only on one frame of existing image, or may be generated based on one frame of existing image and a piece of descriptive text.

### SUMMARY

Embodiments of the present disclosure describe a media generation method, an apparatus, a device, and a medium.

According to a first aspect, there is provided a media generation method, including: obtaining a reference image and a noise image; obtaining control information for guiding media generation, the control information including information of a target subject in the reference image, information of a processing category to which the target subject belongs, and movement guidance information of the target subject; and performing, using a target model and based on the reference image and the control information, denoising processing on the noise image to obtain a target media, such that the target subject in the target media moves according to the movement guidance information.

According to a second aspect, there is provided a media generation apparatus, including: an obtaining unit configured to obtain a reference image and a noise image; a control unit configured to obtain control information for guiding media generation, the control information including information of a target subject in the reference image, information of a processing category to which the target subject belongs, and movement guidance information of the target subject; and a denoising unit configured to perform, using a target model and based on the reference image and the control information, denoising processing on the noise image to obtain a target media, such that the target subject in the target media moves according to the movement guidance information.

According to a third aspect, there is provided a computer program product including a computer program, where when the computer program is executed by a processor, the method according to any one of the implementations of the first aspect is implemented.

According to a fourth aspect, there is provided a computer-readable storage medium having a computer program stored thereon, where when the computer program is executed in a computer, the computer is caused to perform the method according to any one of the implementations of the first aspect.

According to a fifth aspect, there is provided an electronic device including a memory and a processor, where the memory stores executable code, and when the processor executes the executable code, the method according to any one of the implementations of the first aspect is implemented.

According to the media generation solution provided in embodiments of the present disclosure, a reference image and a noise image are obtained, and control information for guiding media generation is obtained, the control information including information of a target subject in the reference image, information of a processing category to which the target subject belongs, and movement guidance information of the target subject; and denoising processing is performed using a target model and based on the reference image and the control information, on the noise image to obtain a target media, such that the target subject in the target media moves according to the movement guidance information.

### BRIEF DESCRIPTION OF THE DRAWINGS

FIG. 1 is a schematic diagram of a scenario of media generation according to an exemplary embodiment of the present disclosure;

FIG. 2 is a flowchart of a media generation method according to an exemplary embodiment of the present disclosure;

FIG. 3 is a block diagram of a media generation apparatus according to an exemplary embodiment of the present disclosure; and

FIG. 4 is a schematic block diagram of an electronic device according to some embodiments of the present disclosure.

### DETAILED DESCRIPTION OF EMBODIMENTS

It may be understood that before the use of the technical solutions disclosed in embodiments of the present disclosure, the user shall be informed of the type, range of use, use scenarios, etc., of personal information involved in the present disclosure in an appropriate manner and the authorization of the user shall be obtained in accordance with relevant laws and regulations.

For example, in response to reception of an active request from a user, prompt information is sent to the user to clearly inform the user that the requested operation will require access to and use of personal information of the user. As such, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It may be understood that the above process of notifying the user and obtaining user authorization is only illustrative and does not constitute a limitation on the implementations of the present disclosure, and other manners that satisfy the relevant laws and regulations may also be applied in the implementations of the present disclosure.

The technical solutions provided in the present disclosure are further described in detail below with reference to the drawings and embodiments. It may be understood that the specific embodiments described herein are only used to explain the related disclosure, but not to limit the disclosure. In addition, it should be noted that, for the convenience of description, only the parts related to the disclosure are shown in the drawings. It should be noted that the embodiments of the present disclosure and the features in the embodiments may be combined with each other without conflict.

Currently, a machine learning-based method may be used to generate a related video or animation based on an existing image. In related technologies, a video or animation is generally generated based only on one frame of existing image, or may be generated based on one frame of existing image and a piece of descriptive text. Therefore, a video or animation cannot be precisely generated according to user intention, which is difficult to meet user requirements. At present, a media generation solution is desired.

In the media generation solution provided in the present disclosure, a reference image and a noise image are obtained, and control information for guiding media generation is obtained, the control information including information of a target subject in the reference image, information of a processing category to which the target subject belongs, and movement guidance information of the target subject; and denoising processing is performed using a target model and based on the reference image and the control information, on the noise image to obtain a target media, such that the target subject in the target media moves according to the movement guidance information. Therefore, the moving target subject in the target media may move according to user intention, which not only enriches media generation approaches, but also better meets user requirements and improves user experience.

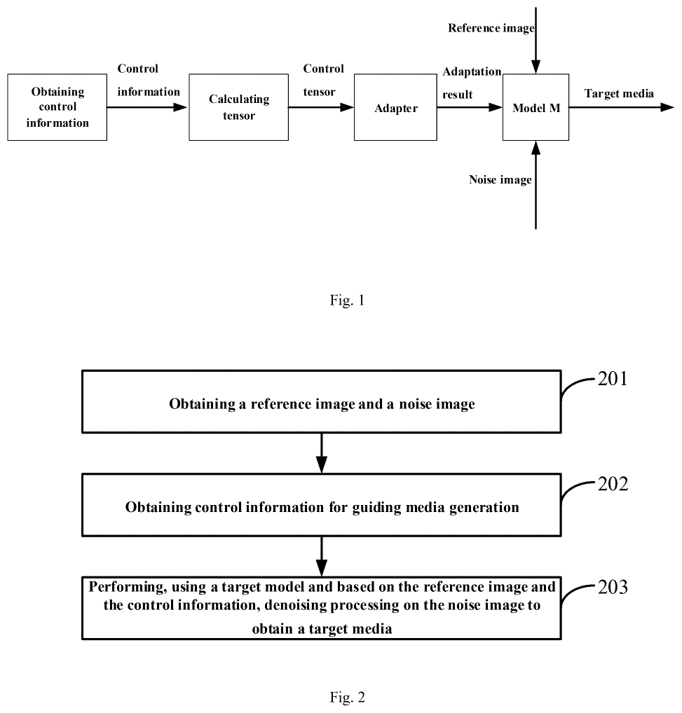

FIG. 1 is a schematic diagram of a scenario of media generation according to an exemplary embodiment.

As shown in FIG. 1, the application stage of a model M is used as an example, where the model M may be a pre-trained diffusion model. First, a user may select one frame of reference image and perform operations through a user interface provided by a terminal device, to select a target subject in the reference image and set information of a processing category to which the target subject belongs and movement guidance information of the target subject. For example, the user may set, through a camera movement setting interface, camera movement parameter information for guiding all target subjects to move according to a camera movement trajectory. The user may further set, through a trajectory setting interface, specified trajectory information for guiding a target subject a to move in a specified manner. The user may further set, through a random movement setting interface, random movement intensity information for guiding the target subject a and a target subject b to move in a random manner. The camera movement parameter information, the specified trajectory information, and the random movement intensity information may be used as control information.

Next, a control tensor may be calculated based on the control information, and the control tensor may include a tensor 1 representing a movement trajectory, a tensor 2 representing random movement intensity, a tensor 3 representing a target subject identification, and a tensor 4 representing a processing category to which the target subject belongs. The control tensor is input into an adapter for adaptation processing, to obtain an adaptation result. Finally, the reference image, the adaptation result, and a noise image may be input into the pre-trained model M, such that the model M may perform denoising processing on the noise image based on the reference image and the adaptation result, to obtain a target media.

The present disclosure is described in detail below with reference to specific embodiments.

FIG. 2 is a flowchart of a media generation method according to an exemplary embodiment. The method may be applied to a terminal device. In this embodiment, for ease of understanding, a terminal device in which a media processing application may be installed is used as an example. It may be understood by those skilled in the art that the terminal device may include, but is not limited to, a mobile terminal device such as a smartphone, a smart wearable device, a tablet computer, a desktop computer, etc. The method may be applied to the application stage of a target model, and may also be applied to a reverse process in a training stage of the target model, where the target model may be a diffusion model, and the method may include the following steps.

As shown in FIG. 2, in step 201, a reference image and a noise image are obtained.

In this embodiment, the media that needs to be generated may be a dynamic media composed of multiple frames of images, for example, the media may be a video, an animation, a dynamic image, or the like. The noise image may be a random noise image, for example, a noise image randomly generated using white Gaussian noise. The specific manner of generating the noise image is not limited in this embodiment. The reference image may provide a reference and basis for media generation, and multiple frames of coherent images may be generated based on the reference image. The multiple frames of coherent images with the reference image as the first frame of image may constitute a target media. If in the application stage of the target model, the reference image may be any frame of image selected or input by the user. If in the reverse process in the training stage of the target model, a sample media may be obtained first, and a first frame of image of the sample media is used as the reference image.

In step 202, control information for guiding media generation is obtained.

In this embodiment, the control information may be used to guide media generation, and the control information may include information of a target subject in the reference image, information of a processing category to which the target subject belongs, and movement guidance information of the target subject. The reference image may include one or more target subjects, each target subject may be a semantic unit in the image, and processing involving movement may be performed in unit of a semantic unit, such that the target subject in the generated media may move in a preset manner. For example, the target subject may be a person in the reference image, an animal in the reference image, or an object in the reference image.

Specifically, the information of the target subject may be unique identification information used to indicate the target subject in the reference image, for example, the information of the target subject may be area information of the target subject in the reference image, or may be number information of a semantic unit to which the target subject belongs in the reference image. The information of the processing category to which the target subject belongs may be, for example, number information corresponding to the category to which the target subject belongs. The processing category may include a first category, a second category, and a third category, the first category is a category processed according to a specified camera movement manner, a specified movement manner, and a random movement manner, the second category is a category processed according to the specified camera movement manner and the random movement manner, and the third category is a category processed according to the specified camera movement manner. For example, if a processing category to which a subject A belongs is the first category, in the generated media, the subject A may move in a specified manner (for example, move according to a specified path) and in a random manner in a specified camera movement effect, that is, the movement of the subject A includes a part of moving according to the specified path and a part of random movement, and has a camera movement effect. If a processing category to which the subject A belongs is the second category, in the generated media, the subject A moves in a random manner in the specified camera movement effect. If a processing category to which the subject A belongs is the third category, in the generated media, the subject A moves with the camera movement effect in the specified camera movement effect.

The movement guidance information of the target subject may be information used to guide movement processing of the target subject. The movement guidance information may include at least one of the following: camera movement parameter information for guiding the target subject to move according to a camera movement trajectory; specified trajectory information for guiding the target subject to move in a specified manner; and random movement intensity information for guiding the target subject to move in a random manner. For example, for a target subject belonging to the first category, the movement guidance information may include the camera movement parameter information, the specified trajectory information, and the random movement intensity information. For a target subject belonging to the second category, the movement guidance information may include the camera movement parameter information and the random movement intensity information. For a target subject belonging to the third category, the movement guidance information may include the camera movement parameter information. The random movement intensity information may be a value used to represent an amount of random movement, and may be represented by a random movement intensity value. The larger the random movement intensity value, the more the amount of random movement (that is, the longer the path of random movement); the smaller the random movement intensity value, the less the amount of random movement. The camera movement parameter information may be information that may represent a camera movement trajectory and indicate camera movement processing.

In this embodiment, in the application stage of the target model, the control information for guiding media generation may be obtained as follows: first, the terminal device may output the reference image to the user through a user interface, and the user performs a first operation and a second operation on the reference image through the user interface. The first operation is an operation of selecting the target subject and setting the processing category to which the target subject belongs, and the second operation is an operation of setting the movement guidance information of the target subject. Finally, the target subject and the information of the processing category to which the target subject belongs may be determined based on the first operation of the user, and the movement guidance information of the target subject may be determined based on the second operation of the user.

For example, for the first operation of the user, in an implementation, the terminal device may display the reference image through an operation interface of an application for generating the media, and the user may frame out the target subject separately on the operation interface. The terminal device may segment the target subject from the area framed out by the user through semantic segmentation and number the target subject, to obtain the information of the target subject. In addition, the user sets a processing category for each target subject, for example, after the user frames out the target subject, the user may trigger buttons of different processing categories to set a processing category for the framed-out target subject. Specifically, after the user frames out a subject 1 and triggers a button corresponding to the first category, a processing category of the subject 1 may be set to the first category. For another example, the user may also, before framing out the target subject, trigger the buttons of different processing categories first and then frame out the target subject, to set a processing category for the target subject. Specifically, after the user triggers a button corresponding to the second category and then frames out a subject 2, a processing category of the subject 2 may be set to the second category.

In another implementation, the terminal device may first perform semantic segmentation on the reference image, to obtain multiple semantic areas, and number each semantic area. Then, the reference image after semantic segmentation is displayed through the operation interface of the application for generating the media, and the user may select, by triggering, a semantic area as the target subject on the operation interface, and a number of the semantic area may be obtained as the information of the target subject. In addition, the user sets a processing category for each target subject, for example, after the user selects the target subject, the user may trigger buttons of different processing categories to set a processing category for the selected target subject. For another example, the user may also trigger, before selecting the target subject, the buttons of different processing categories first and then select the target subject, to set a processing category for the target subject.

For the second operation of the user, after selecting the target subject and setting the processing category to which the target subject belongs, the user may then set the movement guidance information of the target subject. For example, for a target subject belonging to the first category, the user may draw trajectory information of the target subject by dragging on a screen (for example, translating or rotating the target subject), and set an intensity value of random movement as the random movement intensity information by means of selection or input, and set camera movement parameters through a camera movement parameter setting button. For a target subject belonging to the second category, the user may set an intensity value of random movement as the random movement intensity information by means of selection or input, and set camera movement parameters through the camera movement parameter setting button. For a target subject belonging to the third category, the user may set camera movement parameters only through the camera movement parameter setting button. It should be noted that if the reference image includes multiple target subjects, unified camera movement parameters may be set for the multiple target subjects, and it is not necessary to set different camera movement parameters for each target subject.

In this embodiment, in the reverse process in the training stage of the target model, the control information for guiding media generation may be obtained as follows: first, before the reference image is obtained, a sample media may be obtained first. The sample media may be a pre-recorded or pre-produced video, animation, or dynamic image, and the sample media may include at least one movable subject. A first frame of image of the sample media may be obtained as the reference image, and semantic segmentation is performed on the reference image to obtain multiple semantic areas, and each semantic area is numbered. Next, multiple target subjects are determined based on a result of the semantic segmentation, and information of processing categories to which the multiple target subjects belong is set. For example, the processing category to which the target subject belongs may be specified by the user, or the processing category to which the target subject belongs may be randomly set. Finally, the movement guidance information of the target subject may be determined based on image frames after the reference image in the sample media and the information of the processing category to which the target subject belongs.

Specifically, pixel points corresponding to the target subject in the image may be determined according to the reference image first. Each frame of image in the sample video is obtained, and spatial coordinates corresponding to each pixel point in each frame of image are calculated through analysis on these image frames. Then, the pixel points corresponding to the target subject in each frame of image and the spatial coordinates corresponding to each pixel point are determined, to obtain the trajectory data corresponding to the target subject.

In addition, different trajectory functions may be set in advance for different processing categories, each trajectory function includes a specified movement function term and a random movement function term, and at least one function term in trajectory functions corresponding to target subjects belonging to different processing categories is different. For example, a specified movement function term and a random movement function term corresponding to a target subject of the first category are different from those corresponding to a target subject of the third category. A specified movement function term corresponding to a target subject of the first category is different from that corresponding to a target subject of the second category. A random movement function term corresponding to a target subject of the third category is different from that corresponding to a target subject of the second category. The specified movement function term corresponding to the target subject of the third category and the specified movement function term corresponding to the target subject of the second category may be a unit matrix. The random movement function term corresponding to the target subject of the third category may be a zero matrix. Therefore, the trajectory function corresponding to the target subject may be determined according to the processing category to which the target subject belongs.

It should be noted that the specified movement function term included in the trajectory function is related to the specified trajectory information in the movement guidance information, and the random movement function term included in the trajectory function is related to the random movement intensity information in the movement guidance information.

Finally, the movement guidance information of the target subject may be determined based on the trajectory data corresponding to the target subject and the trajectory function corresponding to the target subject. For example, for the target subject of the first category, multiple simulated trajectories input by the user may be randomly simulated first, each simulated trajectory is checked using the trajectory data corresponding to the target subject, and a simulated trajectory closest to the trajectory data corresponding to the target subject is selected as the specified trajectory information for guiding the target subject to move in the specified manner in the movement guidance information of the target subject. Then, the specified movement function term in the trajectory function corresponding to the target subject is subtracted from the trajectory data corresponding to the target subject to obtain the random movement function term in the trajectory function corresponding to the target subject, and based on the random movement function term, the random movement intensity information for guiding the target subject to move in the random manner in the movement guidance information of the target subject is obtained.

For another example, for the target subject of the second category, the random movement function term in the trajectory function corresponding to the target subject may be obtained directly according to the trajectory data corresponding to the target subject, and based on the random movement function term, the random movement intensity information for guiding the target subject to move in the random manner in the movement guidance information of the target subject is obtained. Based on the specified movement function term corresponding to the target subject of the second category, a unit matrix may be used to represent the specified trajectory information for guiding the target subject to move in the specified manner.

For the target subject of the third category, based on the specified movement function term and the random movement function term corresponding to the target subject of the third category, a unit matrix may be used to represent the specified trajectory information for guiding the target subject to move in the specified manner, and a zero matrix may be used to represent the random movement intensity information for guiding the target subject to move in the random manner.

It should be noted that for any frame of reference image, no matter how many target subjects are included in the reference image, a preset algorithm may be first used to analyze each frame of image in the sample media to parse out the camera movement parameter information. The camera movement parameter information may be used as the camera movement parameter information corresponding to each target subject.

In step 203, denoising processing is performed, using a target model and based on the reference image and the control information, on the noise image to obtain a target media.

In this embodiment, a control tensor may be obtained based on the control information. The control tensor may include a first tensor representing a movement trajectory, a second tensor representing random movement intensity, a third tensor representing a target subject identification, and a fourth tensor representing a processing category to which the target subject belongs. Specifically, for example, after the specified trajectory information and the camera movement parameter information included in the control information are determined, movement fusion processing may be performed based on the specified trajectory information and the camera movement parameter information, to obtain the first tensor in which the specified trajectory and the camera movement trajectory are fused. Then, the second tensor is generated according to the random movement intensity information, the third tensor is generated according to a number corresponding to the target subject, and the fourth tensor is generated according to the processing category to which the target subject belongs. It should be noted that if the control information includes only the specified trajectory information, the first tensor may be directly generated according to the specified trajectory information. If the control information includes only the camera movement parameter information, the first tensor is directly generated according to the camera movement parameter information.

Then, the control tensor is input into a target adapter to obtain a target result output by the target adapter. In the application stage of the target model, the target adapter may be a pre-trained adapter. In the reverse process in the training stage of the target model, the target adapter may be an adapter to be trained, and in a parameter adjustment process, only parameters of the target adapter may be adjusted, and the parameters of the target model do not need to be adjusted.

Finally, the reference image and the target result may be used to guide the target model to perform denoising processing on the noise image. Specifically, the reference image, the target result, and the noise image may be input into the target model separately, such that the target model may perform denoising processing on the noise image based on the reference image and the target result, to obtain the target media in which the target subject moves according to the movement guidance information.

According to the media generation method provided in the present disclosure, a reference image and a noise image are obtained, and control information for guiding media generation is obtained, the control information including information of a target subject in the reference image, information of a processing category to which the target subject belongs, and movement guidance information of the target subject; and denoising processing is performed using a target model and based on the reference image and the control information, on the noise image to obtain a target media, such that the target subject in the target media moves according to the movement guidance information. Therefore, the moving target subject in the target media may move according to user intention, which not only enriches media generation approaches, but also better meets user requirements and improves user experience.

It should be noted that although the operations of the method in embodiments of the present disclosure are described in a particular order in the above embodiments, this does not require or imply that the operations must be performed in this particular order, or all the operations shown must be performed to achieve the desired results. On the contrary, the order of execution of the steps depicted in the flowchart may be changed. Additionally or alternatively, some steps may be omitted, multiple steps may be combined into one step for execution, and/or one step may be decomposed into multiple steps for execution.

Corresponding to the foregoing media generation method embodiments, the present disclosure further provides embodiments of a media generation apparatus.

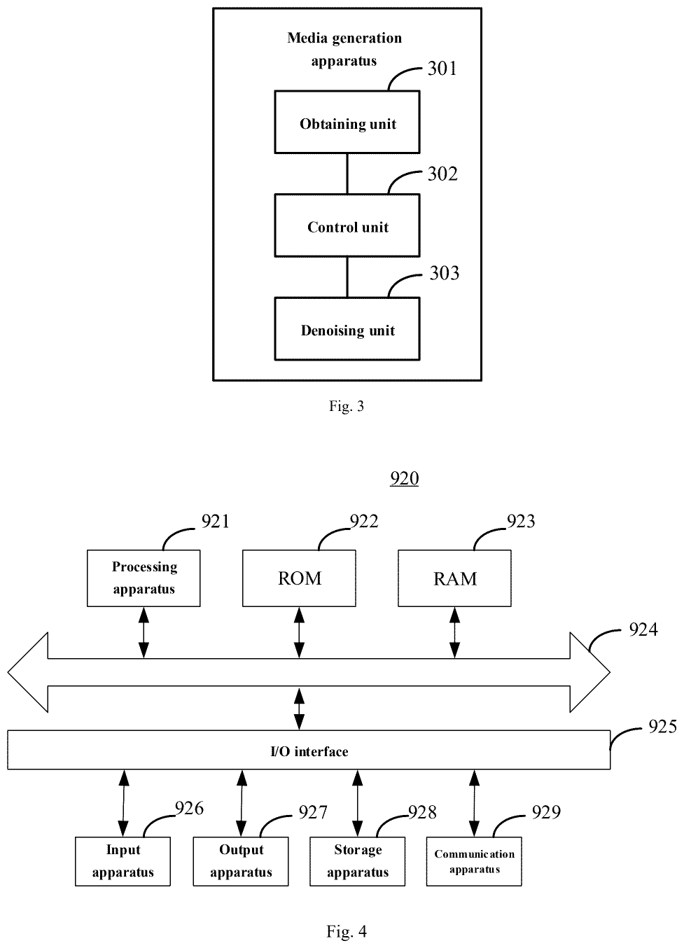

As shown in FIG. 3 which is a block diagram of a media generation apparatus according to an exemplary embodiment of the present disclosure, the apparatus may include: an obtaining unit 301, a control unit 302, and a denoising unit 303.

The obtaining unit 301 is configured to obtain a reference image and a noise image.

The control unit 302 is configured to obtain control information for guiding media generation, the control information including information of a target subject in the reference image, information of a processing category to which the target subject belongs, and movement guidance information of the target subject.

The denoising unit 303 is configured to perform, using a target model and based on the reference image and the control information, denoising processing on the noise image to obtain a target media, such that the target subject in the target media moves according to the movement guidance information.

In some implementations, the processing category includes a first category processed according to a specified camera movement manner, a specified movement manner, and a random movement manner, a second category processed according to the specified camera movement manner and the random movement manner, and a third category processed according to the specified camera movement manner.

In some other implementations, the movement guidance information includes at least one of the following: camera movement parameter information for guiding the target subject to move according to a camera movement trajectory; specified trajectory information for guiding the target subject to move in a specified manner; and random movement intensity information for guiding the target subject to move in a random manner.

In some other implementations, in an application stage of the target model, the control unit is configured to: determine a first operation and a second operation performed by a user on the reference image; determine the target subject and the information of the processing category to which the target subject belongs based on the first operation; and determine the movement guidance information of the target subject based on the second operation.

In some other implementations, in a training stage of the target model, before the reference image is obtained, the apparatus further includes: a sample obtaining unit configured to obtain a sample media.

The obtaining unit is configured to obtain a first frame of image of the sample media as the reference image.

The control unit is configured to perform semantic segmentation on the reference image and determine multiple target subjects based on a result of the semantic segmentation; set information of processing categories to which the multiple target subjects belong; and determine the movement guidance information of the target subject based on image frames after the reference image in the sample media and the information of the processing category to which the target subject belongs.

In some other implementations, the movement guidance information of the target subject is determined based on the image frames after the reference image in the sample video and the processing category to which the target subject belongs as follows: trajectory data corresponding to the target subject is determined according to the image frames after the reference image in the sample video; a trajectory function corresponding to the target subject is determined according to the processing category to which the target subject belongs; and the movement guidance information of the target subject is determined based on the trajectory data and the trajectory function.

In some other implementations, the trajectory function includes a specified movement function term and a random movement function term; and at least one function term in trajectory functions corresponding to target subjects belonging to different processing categories is different.

In some other implementations, the denoising unit is configured to obtain a control tensor based on the control information, the control tensor including a first tensor representing a movement trajectory, a second tensor representing random movement intensity, a third tensor representing a target subject identification, and a fourth tensor representing the processing category to which the target subject belongs; input the control tensor into a target adapter to obtain a target result output by the target adapter; and guide the target model to perform denoising processing on the noise image using the reference image and the target result.

For the apparatus embodiment, since it basically corresponds to the method embodiment, reference may be made to the partial description of the method embodiment for relevant parts. The apparatus embodiment described above is merely illustrative, where the units described as separate parts may or may not be physically separate, and the parts displayed as units may or may not be physical units, that is, they may be located in one place or distributed to multiple network units. Some or all of the modules may be selected according to actual needs to achieve the purpose of the solutions of the embodiments of the present disclosure. It may be understood and implemented by those of ordinary skill in the art without creative efforts.

Reference is made to FIG. 4 below, which is a schematic block diagram of an electronic device according to some embodiments of the present disclosure. The electronic device 920 is, for example, suitable for implementing the media generation method provided in embodiments of the present disclosure. The electronic device 920 may be a terminal device or the like, and may be used to implement a client or a server. The electronic device 920 may include, but is not limited to, mobile terminals such as a mobile phone, a notebook computer, a digital broadcast receiver, a personal digital assistant (PDA), a tablet computer, a portable multimedia player (PMP), a vehicle-mounted terminal (such as a vehicle navigation terminal), and a wearable electronic device, and fixed terminals such as a digital TV, a desktop computer, and a smart home device. It should be noted that the electronic device 920 shown in FIG. 4 is only an example, which does not impose any limitation on the function and scope of use of the embodiments of the present disclosure.

As shown in FIG. 4, the electronic device 920 may include a processing apparatus (e.g., a central processing unit, a graphics processing unit, etc.) 921 that may perform various appropriate actions and processing according to a program stored in a read-only memory (ROM) 922 or a program loaded from a storage apparatus 928 into a random access memory (RAM) 923. The RAM 923 further stores various programs and data required for operations of the electronic device 920. The processing apparatus 921, the ROM 922, and the RAM 923 are connected to each other through a bus 924. An input/output (I/O) interface 925 is also connected to the bus 924.

Usually, the following apparatuses may be connected to the I/O interface 925: an input apparatus 926 including, for example, a touch screen, a touchpad, a keyboard, a mouse, a camera, a microphone, an accelerometer, a gyroscope, or the like; an output apparatus 927 including, for example, a liquid crystal display (LCD), a speaker, a vibrator, or the like; a storage apparatus 928 including, for example, a magnetic tape, a hard disk, or the like; and a communication apparatus 929. The communication apparatus 929 may allow the electronic device 920 to perform wireless or wired communication with other electronic devices to exchange data. Although FIG. 4 shows the electronic device 920 having various apparatuses, it should be understood that it is not required to implement or have all the apparatuses shown, and the electronic device 920 may alternatively implement or have more or fewer apparatuses. Each block shown in FIG. 4 may represent one apparatus or multiple apparatuses as needed.

According to an embodiment of the present disclosure, the media generation method may be implemented as a computer software program. For example, an embodiment of the present disclosure includes a computer program product including a computer program carried on a non-transitory computer-readable medium, where the computer program includes program code for performing the media generation method. In such an embodiment, the computer program may be downloaded and installed from a network through the communication apparatus 929, or installed from the storage apparatus 928, or installed from the ROM 922. When the computer program is executed by the processing apparatus 921, the functions defined in the media generation method provided in embodiments of the present disclosure may be implemented.

An embodiment of the present disclosure further provides a computer-readable storage medium having a computer program stored thereon, where when the computer program is executed in a computer, the computer is caused to perform the method provided in the present disclosure.

It should be noted that the computer-readable medium according to embodiments of the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus or device, or any suitable combination of the foregoing. More specific examples of the computer-readable storage medium may include, but are not limited to: an electrical connection with one or more wires, portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing. In embodiments of the present disclosure, the computer-readable storage medium may be any tangible medium that includes or stores a program, which may be used by or in combination with an instruction execution system, apparatus, or device. In embodiments of the present disclosure, the computer-readable signal medium may include a data signal propagated on a baseband or as a part of a carrier, and computer-readable program code is carried therein. The data signal propagated in this manner may be in multiple forms, and includes, but is not limited to, an electromagnetic signal, an optical signal, or any suitable combination of the foregoing. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted in any suitable medium, including but not limited to: a wire, an optical cable, a radio frequency (RF), or any suitable combination of the foregoing.

The computer program code for performing the operations of the embodiments of the present disclosure may be written in one or more programming languages or a combination thereof, where the programming languages include object-oriented programming languages such as Java, Smalltalk, and C++, and further include conventional procedural programming languages such as “C” language or similar programming languages. The program code may be completely executed on a user computer, partially executed on a user computer, executed as an independent software package, partially executed on a user computer and partially executed on a remote computer, or completely executed on a remote computer or server. In the scenario involving the remote computer, the remote computer may be connected to the user computer through any kind of network, including a local area network (LAN) or a wide area network (WAN), or may be connected to an external computer (for example, connected through the Internet with the aid of an Internet service provider).

The embodiments in the present disclosure are all described in a progressive manner, and the same and similar parts between the embodiments may be referred to each other, and each embodiment focuses on the differences from other embodiments. In particular, the embodiments of the storage medium and the computing device are described relatively simply since they are basically similar to the method embodiment, and reference may be made to the partial description of the method embodiment for relevant parts.

It should be realized by those skilled in the art that in one or more of the above examples, the functions described in the embodiments of the present disclosure may be implemented in hardware, software, firmware, or any combination thereof. When software is used to implement the functions, the functions may be stored in a computer-readable medium or transmitted as one or more instructions or pieces of program code on the computer-readable medium.

The foregoing specific implementations further describe the purpose, technical solutions, and beneficial effects of the embodiments of the present disclosure in detail. It should be understood that the foregoing descriptions are only specific implementations of the embodiments of the present disclosure, and are not intended to limit the protection scope of the present disclosure. Any modifications, equivalent substitutions, improvements, etc. made on the basis of the technical solutions of the present disclosure shall fall within the protection scope of the present disclosure.

1. A media generation method, comprising:
obtaining a reference image and a noise image;
obtaining control information for guiding media generation, the control information comprising information of a target subject in the reference image, information of a processing category to which the target subject belongs, and movement guidance information of the target subject; and
performing, using a target model and based on the reference image and the control information, denoising processing on the noise image to obtain a target media, such that the target subject in the target media moves according to the movement guidance information.

2. The method of claim 1, wherein the processing category comprises a first category processed according to a specified camera movement manner, a specified movement manner, and a random movement manner, a second category processed according to the specified camera movement manner and the random movement manner, and a third category processed according to the specified camera movement manner.

3. The method of claim 1, wherein the movement guidance information comprises at least one of the following:
camera movement parameter information for guiding the target subject to move according to a camera movement trajectory;
specified trajectory information for guiding the target subject to move in a specified manner; and
random movement intensity information for guiding the target subject to move in a random manner.

4. The method of claim 1, wherein in an application stage of the target model, the obtaining control information for guiding media generation comprises:
determining a first operation and a second operation performed by a user on the reference image;
determining the target subject and the information of the processing category to which the target subject belongs based on the first operation; and
determining the movement guidance information of the target subject based on the second operation.

5. The method of claim 1, wherein in a training stage of the target model, before the reference image is obtained, the method further comprises: obtaining a sample media;
wherein the obtaining a reference image comprises:
obtaining a first frame of image of the sample media as the reference image;
wherein the obtaining control information for guiding media generation comprises:
performing semantic segmentation on the reference image, and determining multiple target subjects based on a result of the semantic segmentation;
setting information of processing categories to which the multiple target subjects belong; and
determining the movement guidance information of the target subject based on image frames after the reference image in the sample media and the information of the processing category to which the target subject belongs.

6. The method of claim 5, wherein the determining the movement guidance information of the target subject based on image frames after the reference image in the sample video and the processing category to which the target subject belongs comprises:
determining trajectory data corresponding to the target subject according to the image frames after the reference image in the sample video;
determining a trajectory function corresponding to the target subject according to the processing category to which the target subject belongs; and
determining the movement guidance information of the target subject based on the trajectory data and the trajectory function.

7. The method of claim 6, wherein the trajectory function comprises a specified movement function term and a random movement function term; and at least one function term in trajectory functions corresponding to target subjects belonging to different processing categories is different.

8. The method of claim 1, wherein the performing, using a target model and based on the reference image and the control information, denoising processing on the noise image comprises:
obtaining a control tensor based on the control information, the control tensor comprising a first tensor representing a movement trajectory, a second tensor representing random movement intensity, a third tensor representing a target subject identification, and a fourth tensor representing the processing category to which the target subject belongs;
inputting the control tensor into a target adapter to obtain a target result output by the target adapter; and
guiding the target model to perform denoising processing on the noise image using the reference image and the target result.

9. A non-transitory computer-readable storage medium having a computer program stored thereon, wherein when the computer program is executed in a computer, the computer is caused to perform a media generation method, comprising:
obtaining a reference image and a noise image;
obtaining control information for guiding media generation, the control information comprising information of a target subject in the reference image, information of a processing category to which the target subject belongs, and movement guidance information of the target subject; and
performing, using a target model and based on the reference image and the control information, denoising processing on the noise image to obtain a target media, such that the target subject in the target media moves according to the movement guidance information.

10. The method of claim 9, wherein the processing category comprises a first category processed according to a specified camera movement manner, a specified movement manner, and a random movement manner, a second category processed according to the specified camera movement manner and the random movement manner, and a third category processed according to the specified camera movement manner.

11. The non-transitory computer-readable storage medium of claim 9, wherein the movement guidance information comprises at least one of the following:
camera movement parameter information for guiding the target subject to move according to a camera movement trajectory;
specified trajectory information for guiding the target subject to move in a specified manner; and
random movement intensity information for guiding the target subject to move in a random manner.

12. The non-transitory computer-readable storage medium of claim 9, wherein in an application stage of the target model, the obtaining control information for guiding media generation comprises:
determining a first operation and a second operation performed by a user on the reference image;
determining the target subject and the information of the processing category to which the target subject belongs based on the first operation; and
determining the movement guidance information of the target subject based on the second operation.

13. The non-transitory computer-readable storage medium of claim 9, wherein in a training stage of the target model, before the reference image is obtained, the method further comprises: obtaining a sample media;
wherein the obtaining a reference image comprises:
obtaining a first frame of image of the sample media as the reference image;
wherein the obtaining control information for guiding media generation comprises:
performing semantic segmentation on the reference image, and determining multiple target subjects based on a result of the semantic segmentation;
setting information of processing categories to which the multiple target subjects belong; and
determining the movement guidance information of the target subject based on image frames after the reference image in the sample media and the information of the processing category to which the target subject belongs.

14. The non-transitory computer-readable storage medium of claim 13, wherein the determining the movement guidance information of the target subject based on image frames after the reference image in the sample video and the processing category to which the target subject belongs comprises:
determining trajectory data corresponding to the target subject according to the image frames after the reference image in the sample video;
determining a trajectory function corresponding to the target subject according to the processing category to which the target subject belongs; and
determining the movement guidance information of the target subject based on the trajectory data and the trajectory function.

15. An electronic device comprising a memory and a processor, wherein the memory stores executable code, and the executable code, when executed by the processor, causes the processor to implement a media generation method, comprising:
obtaining a reference image and a noise image;
obtaining control information for guiding media generation, the control information comprising information of a target subject in the reference image, information of a processing category to which the target subject belongs, and movement guidance information of the target subject; and
performing, using a target model and based on the reference image and the control information, denoising processing on the noise image to obtain a target media, such that the target subject in the target media moves according to the movement guidance information.

16. The electronic device of claim 15, wherein the processing category comprises a first category processed according to a specified camera movement manner, a specified movement manner, and a random movement manner, a second category processed according to the specified camera movement manner and the random movement manner, and a third category processed according to the specified camera movement manner.

17. The electronic device of claim 15, wherein the movement guidance information comprises at least one of the following:
camera movement parameter information for guiding the target subject to move according to a camera movement trajectory;
specified trajectory information for guiding the target subject to move in a specified manner; and
random movement intensity information for guiding the target subject to move in a random manner.

18. The electronic device of claim 15, wherein in an application stage of the target model, the obtaining control information for guiding media generation comprises:
determining a first operation and a second operation performed by a user on the reference image;
determining the target subject and the information of the processing category to which the target subject belongs based on the first operation; and
determining the movement guidance information of the target subject based on the second operation.

19. The electronic device of claim 15, wherein in a training stage of the target model, before the reference image is obtained, the method further comprises: obtaining a sample media;
wherein the obtaining a reference image comprises:
obtaining a first frame of image of the sample media as the reference image;
wherein the obtaining control information for guiding media generation comprises:
performing semantic segmentation on the reference image, and determining multiple target subjects based on a result of the semantic segmentation;
setting information of processing categories to which the multiple target subjects belong; and
determining the movement guidance information of the target subject based on image frames after the reference image in the sample media and the information of the processing category to which the target subject belongs.

20. The electronic device of claim 19, wherein the determining the movement guidance information of the target subject based on image frames after the reference image in the sample video and the processing category to which the target subject belongs comprises:
determining trajectory data corresponding to the target subject according to the image frames after the reference image in the sample video;
determining a trajectory function corresponding to the target subject according to the processing category to which the target subject belongs; and
determining the movement guidance information of the target subject based on the trajectory data and the trajectory function.
